(19) United States
(12) Patent Application Publication
(10) Pub. No.: US 2006/0175832 A1
(43) Pub. Date: Aug. 10, 2006

(54) Coupler

(75) Inventors: Niels Mueller, Gelnhausen (DE); Bianca Schirmer, Linsengericht/Altenhasslau (DE)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Veritas AG, Gelnhausen (DE)

(21) Appl. No.: 11/292,112

(22) Filed: Dec. 2, 2005

(30) Foreign Application Priority Data
Feb. 10, 2005 (DE) 20 2005 002 159.8

(51) Int. Cl. F16L 39/00

(52) U.S. Cl. 285/319

(57) ABSTRACT

The present invention relates to a coupler comprising a housing including an accommodating means into which an end section of a preferably rigid conduit, which includes at least one securing collar radially projecting relative to the conduit and preferably extending in circumferential direction of the conduit, can be inserted in a direction of insertion, and comprising a retaining means with which the inserted conduit can be secured in a direction opposite to the direction of insertion. To improve such a coupler, it is suggested according to the invention that a securing means should be provided which comprises a fastening section with which the securing means can be fastened in the housing of the coupler, and a securing section, and the securing section in the inserted state of the conduit should be spaced apart from the securing collar in a direction opposite to the insertion direction and adapted to be brought into engagement with the securing collar by the conduit being pulled out.

The present invention relates to a coupler comprising a housing including an accommodating means into which an end section of a preferably rigid conduit, which includes at least one securing collar radially projecting relative to the conduit and preferably extending in circumferential direction of the conduit, can be inserted in a direction of insertion, and comprising a retaining means with which the inserted conduit can be secured in a direction opposite to the direction of insertion.

Such couplers are generally known from the prior art. They are used for either rigid or flexible conduits. Such couplers have turned out to be particularly useful in conduits which are used as fuel lines in automotive vehicles. Such conduits are normally rigid and consist of metal. On their end section said conduits comprise a radially projecting collar extending in the form of a ring in circumferential direction. However, it is also possible that the collar extends not fully, but only partly or in sections in the circumferential direction of the conduit. The housing is essentially cylindrical and has an accommodating means into which the end section of the conduit can be inserted. The accommodating means has positioned therein securing device, such as resilient tongues, which are spread apart by insertion of the conduit and, in the inserted state of the conduit, secure the securing collar of the conduit in a direction opposite to its insertion direction such that it cannot be pulled out. Such couplers have turned out to be reliable and stable. Recently, however, there have been more and more demands that the safety of such couplers should especially be improved in the event of an accident to prevent unintended leakage of fuel and the resulting possible risk of fire.

It is therefore the object of the present invention to improve a coupler of the above-mentioned type such that a reliable connection is established between a conduit and the coupler and leakage of fuel can be efficiently prevented particularly in the event of an accident of the automotive vehicle. In addition, such an improvement should be achievable in a simple way and at low costs.

According to the invention this object is achieved by a coupler of the above-mentioned type which includes a securing means which comprises a fastening section with which the securing means can be fastened to the coupler, and a securing section, and the securing section in the inserted state of the conduit is spaced apart from the securing collar in a direction opposite to the insertion direction and can be brought into engagement with the securing collar by the conduit being pulled out.

Such a solution is simple and has the advantage that an additional second securing means is present that especially in the event of an accident is capable of efficiently preventing leakage of fuel. During normal operation, the coupler is in engagement with the conduit in the known manner. In the event that the conduit is pulled out of its accommodating means in a direction opposite to its insertion direction due to great forces acting on the coupler, as in the case of an accident, the securing means gets into engagement with the conduit. This prevents the coupler and the conduit from being separated from each other.

In an advantageous development, the securing means can be detachably secured to the housing. This is particularly recommended for retrofit solutions. Moreover, the detachable mounting permits a removal of the securing means so that after an accident, or the like, a targeted separation of conduit and coupler is possible.

It may turn out to be particularly advantageous for retrofit solutions when the securing means can be locked via the fastening section to the housing. Such a locking permits a simple and inexpensive mounting.

It may here turn out to be advantageous when the fastening section comprises at least one elastic holding tongue which grips at least in sections around the housing in a circumferential direction and via which the fastening section can be locked to the housing. A simple and efficient connection can thereby also be established between the fastening section and the housing.

To be able to mount the securing device also after the assembly of conduit and coupler, it may turn out to be advantageous when the fastening section can be substantially locked in radial direction of the housing to the housing.

In an advantageous development of the invention, the securing section may comprise at least one securing clip extending at least in sections between the conduit and the outer circumference of the securing collar of the conduit. A form fit can thereby be produced between securing section and securing collar.

To accomplish a symmetrical introduction of forces, it may turn out to be advantageous when two securing clips are provided at opposite sides.

Moreover, it may turn out to be advantageous when the securing clips are elastic. They are then capable of absorbing even large impacts, as may specifically occur in the event of an accident.

It may here turn out to be advantageous when the securing clips are configured as elastic resilient tongues and, upon insertion of the conduit in insertion direction, are transferable by the securing collar from a securing position, in which the securing collar can be brought into engagement with the securing clips in a direction opposite to the insertion direction, into a passage position, so that the conduit can be inserted into the accommodating means. The securing means can thereby also be mounted on the housing before assembly of the conduit.

It may be of advantage if the securing means consists of a resilient elastic material, preferably spring steel. The securing means can thereby be realized in a simple and inexpensive manner with adequate strength and low weight.

In an advantageous development of the invention, the housing may comprise a housing section of a larger outer diameter which includes the accommodating means, and a housing section of a smaller outer diameter. The constructional space of the housing can thereby be made more compact.

Furthermore, it has turned out to be advantageous when the housing section of the larger outer diameter is arranged next to the housing section of the smaller outer diameter. The geometry of the housing can thereby also be used for axially fixing the securing means.

It may be of advantage when the securing means comprises a second fastening section which is mounted on the housing. This improves the connection between securing means and housing.

To achieve an axial fixation of the securing means on the housing in at least one axial direction of the housing, the first fastening section can be arranged on the housing section of the smaller outer diameter and the second fastening section on the housing section of the larger outer diameter.

It may turn out to be advantageous when the first and second fastening sections are interconnected through at least one holding web which is supported on the housing in a direction opposite to the insertion direction.

Furthermore, it may turn out to be advantageous when the second fastening section comprises a support section which grips behind the housing in a form-fit manner, so that the securing means is supported in insertion direction on the housing. An axial fixation of the securing means on the housing can thereby be accomplished as well.

What is additionally claimed is an inventive coupler comprising a conduit, a cylindrical end section of the conduit being here larger than the axial movement of the conduit between inserted position and securing position. It can thereby be ensured that during transfer from the inserted position due to excessive force action and failure of the retaining means into the securing position a seal can be ensured with a single sealing element in both positions. The use of a plurality of axially spaced-apart seals or of seals that are arranged side by side can of course even improve the sealing effect.

The mode of operation of the invention shall now be explained in more detail.

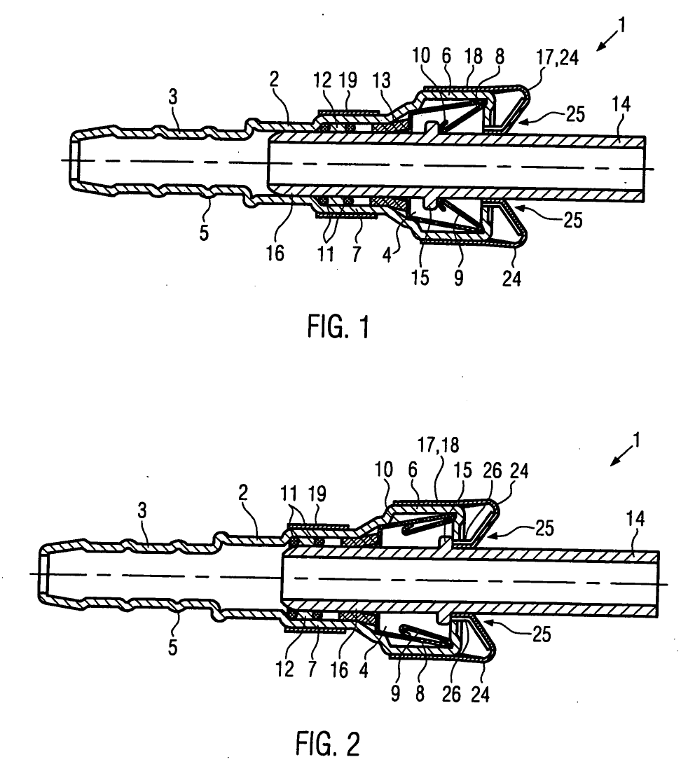

FIG. 1 shows the coupler with inserted conduit; and

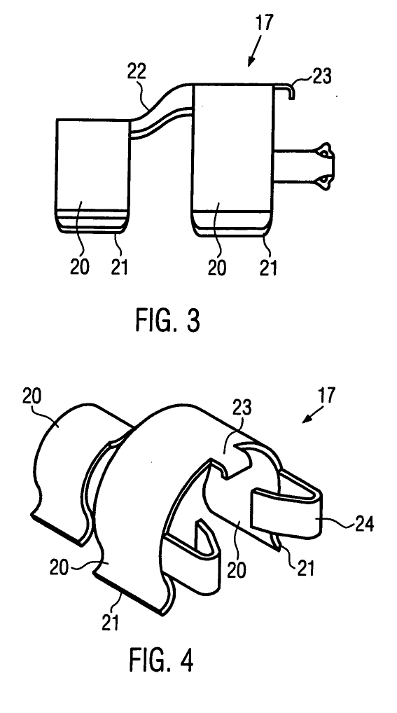

FIG. 2 shows the coupler of FIG. 3 with the conduit being partly pulled out.

FIG. 3 is a side view of the securing means of the invention;

FIG. 4 is a perspective view of the securing means of FIG. 3.

FIG. 1 shows the coupler according to the invention in a sectional view. The coupler has a substantially rotationally symmetrical housing 2 with a connection section 3 and an accommodating means 4. The connection section 3 is substantially tubular and provided with a profile 5 in the form of surrounding projections. A flexible hose can be slid in the known manner onto said connection section 3. The tubular connection section 3 is joined by the accommodating means 4, which is also tubular, the accommodating means 4 being formed by a housing section having an outer diameter larger than the outer diameter of the connection section 3. The outer surface of the housing section 6 is substantially in the form of a cylinder jacket. A further housing section 7 whose outer surface is also substantially in the form of a cylinder jacket and whose outer diameter is smaller than that of the housing section 6 is positioned between the connection section 3 and the housing section 6.

A locking means having flexible locking elements 9 evenly distributed over the circumference of the locking means 5 is positioned in the known manner in the accommodating means 4. In the present embodiment, the locking means includes four locking elements. The locking means is made from spring steel so that end sections 10 of the locking elements 9 can be spread radially to the outside. They are however resiliently biased into the position shown in FIG. 1. Furthermore, two O-rings 11 are provided inside the tubular coupler, as well as a spacer ring 12 disposed thereinbetween. Furthermore, a flexible element 13 is located between the locking means 8 and the assembly consisting of the two O-rings and the spacer ring.

The dimensions of the spacer ring, the O-rings, the flexible element and the locking means are chosen such that a conduit 14 can be inserted in the known manner into the accommodating means. The conduit 14 has a securing collar 15 extending in circumferential direction, which projects radially relative to the outer surface of the remaining conduit. In the present embodiment, the conduit consists of metal and is thus rigid. The housing is also made of metal, so that a rigid connection can be established on the whole. However, it is also possible to use a conduit of a plastic or a flexible material, such as an elastomer, instead of a rigid conduit of metal. The securing collar 15 is spaced apart from a substantially cylindrical end section 16 of the conduit. The conduit can be inserted into the accommodating means of the housing in an insertion direction, i.e. in a direction coaxial to the longitudinal axis of the housing, to assume the configuration according to FIG. 1. The securing collar is dimensioned such that when inserted in insertion direction it first presses the end sections 10 of the locking elements 9 of the locking means 8 radially aside and the end sections 10 of the locking elements 9 grip behind the securing collar 15 in the mounted position of the tube according to FIG. 1. It is in principle also possible that the securing collar is not fully extending in circumferential direction, but only extends sectionwise in circumferential direction.

FIG. 3 shows a securing means 17. The securing means 17 consists of spring steel and has a first fastening section 18 and a second fastening section 19. Each of the first and second fastening sections 18 and 19 have flexible holding tongues 20 which extend arcuately, so that they are adapted to the contour of the housing 2. The holding tongues 20 are provided on their end sections with grip sections 21 which are bent outwards opposite to the curvature of the holding tongue. The first and second fastening sections 18 and 19 are interconnected via a holding web 22. In the mounted state of the securing means according to FIG. 1, each of the holding tongues 20 grips around the associated housing sections 6 and 7 in a biased condition. Moreover, the securing means has a support section 23 which in the mounted state of the securing means extends radially inwards and grips behind the housing, so that the securing means is supported in the direction of insertion on the housing.

Furthermore, the securing means has flexible securing clips 24. In the preferred embodiment, two opposite securing clips 24 are provided. The securing clips are configured such that their end sections 25 are spaced apart from each other at a distance substantially corresponding to the outer diameter of the cylindrical section of the conduit. The securing clips can be expanded radially in the region of their end sections by insertion of the conduit into the coupler in insertion direction so as to permit the passage of the conduit with the securing collar into the housing of the coupler 1. The securing clips 24 are provided at their end sections 25 with sections 26 which extend at least sectionwise in straight fashion and which in the illustration of FIG. 1 are substantially in parallel with the outside of the conduit.

Operation and function of the present invention shall now be explained in more detail.

First of all, the securing means 17 is fastened to the housing 2 of the coupler 1. To this end the holding tongues 20 of the first and section fastening sections 18 and 19 are brought into contact with the housing sections 6 and 7, the grip sections 21 first resting on the housing sections 6 and 7. The holding tongues 20 are spread apart by being pressed in radial direction, and the securing means snaps onto the housing sections 6 and 7 such that it assumes the configuration shown in FIGS. 1 and 2. The holding tongues 20 grip around the associated housing sections 6 and 7 sectionwise. Thanks to this form-fit coupling of the first and second fastening sections with the respectively associated housing sections, the position of the securing means on the housing 2 is fixed. Since the housing section 6 has a larger outer diameter than the housing section 7, and since the two fastening sections are interconnected via the holding web 22, the securing means is fixed on the housing in a direction opposite to the insertion direction. In the insertion direction, the securing means is supported on the support section 23. Due to its design the securing means 17 can be mounted on the housing either before assembly of the conduit or also after assembly of the conduit, i.e. as a retrofit part. Moreover, the securing means 17 can be removed again. This permits an exchange of the securing means, e.g. after a long operation period.

In the present embodiment, the securing means 17 was installed before assembly of the conduit 14. For the assembly of the conduit 14 said member is inserted in the direction of insertion with its end section into the housing 2, the securing collar 15 during such a movement first pressing the end sections 25 of the securing clips 24 apart. After passage through the securing clips these will again snap back into their initial position shown in FIG. 1. During further movement of the conduit in the direction of insertion the end sections of the locking elements 10 are then pressed apart radially. After passage of the securing collar these will again snap back into their initial position. The assembly consisting of coupler 1 and conduit 14 now assumes the configuration shown in FIG. 1. In this configuration, the end sections 10 of the locking elements 9 and the end sections 25 of the securing clips are axially spaced apart from one another. In a direction opposite to the insertion direction the conduit is only supported on the end sections of the locking elements. The end sections of the securing clips are not in engagement.

If during operation the coupler is now exposed to extreme loads, as may e.g. occur in the event of an accident, it may happen that the locking means 8 fails and that the conduit is pulled out of the housing in a direction opposite to the insertion direction. In this process it gets into engagement with the end sections 25 of the securing clips and is supported on said sections. Hence, the securing means forms a second securing device preventing the conduit from being pulled out of the housing. Thanks to the geometry of the conduit and the arrangement of the sealing elements in the form of O-rings, a sealing action is also ensured in the configuration shown in FIG. 2. Hence, leakage of fuel, or the like, is efficiently prevented.

1. A coupler comprising a housing including an accommodating means into which an end section of a preferably rigid conduit, which includes at least one securing collar radially projecting relative to the conduit and preferably extending in circumferential direction of the conduit, can be inserted in a direction of insertion, and comprising a retaining means with which the inserted conduit can be secured in a direction opposite to the direction of insertion, wherein a securing means is provided which comprises a fastening section with which the securing means can be fastened in the housing of the coupler, and a securing section, and the securing section in the inserted state of the conduit is spaced apart from the securing collar in a direction opposite to the insertion direction and can be brought into engagement with the securing collar by the conduit being pulled out.

2. The coupler according to claim 1, wherein the securing means is detachably connectable to the housing.

3. The coupler according to claim 1, wherein the securing means can be locked via the fastening section to the housing.

4. The coupler according to claim 1, wherein the fastening section comprises at least one elastic holding tongue which grips around the housing in circumferential direction at least in sections and through which the fastening section can be locked to the housing.

5. The coupler according to claim 1, wherein the fastening section can be locked substantially in the radial direction of the housing to said housing.

6. The coupler according to claim 1, wherein the securing section comprises at least one securing clip which extends at least in sections between conduit and outer circumference of the securing collar.

7. The coupler according to claim 1, wherein two securing clips are provided at opposite sides.

8. The coupler according to claim 1, wherein the securing clips are elastic.

9. The coupler according to claim 1, wherein the securing clips are configured as elastic resilient tongues and, upon insertion of the conduit in insertion direction, are transferable by the securing collar from a securing position, in which the securing collar can be brought in a direction opposite to the insertion direction into engagement with the securing clip, into a passage position, so that the conduit can be inserted into the accommodating means.

10. The coupler according to claim 1, wherein the securing means consists of resilient elastic material, preferably spring steel.

11. The coupler according to claim 1, wherein the housing has a housing section of a larger outer diameter, which includes the accommodating means, and a housing section of a smaller outer diameter.

12. The coupler according to claim 1, wherein the housing section of the larger outer diameter is arranged next to the housing section of the smaller outer diameter.

13. The coupler according to claim 1, wherein the securing means comprises a second fastening section which is mounted on the housing.

14. The coupler according to claim 1, wherein the first fastening section is arranged on the housing section of the smaller outer diameter and the second fastening section on the housing section of the larger outer diameter.

15. The coupler according to claim 1, wherein the first and the second fastening section are interconnected via at least one holding web which is supported on the housing in a direction opposite to the insertion direction.

16. The coupler according to claim 1, wherein the second fastening section has a support section which grips behind the housing in form-fit manner, so that the securing means is supported on the housing in insertion direction.

17. The coupler according to claim 1, wherein a cylindrical end section of the conduit is larger than the axial movement of the conduit between inserted position and securing position.

18. The coupler according to claim 2, wherein the securing means can be locked via the fastening section to the housing.

19. The coupler according to claim 18, wherein the fastening section comprises at least one elastic holding tongue which grips around the housing in circumferential direction at least in sections and through which the fastening section can be locked to the housing.

20. The coupler according to claim 19, wherein the fastening section can be locked substantially in the radial direction of the housing to said housing.
